(19) United States
(12) Patent Application Publication
(10) Pub. No.: US 2019/0121534 A1
(43) Pub. Date: Apr. 25, 2019

(54) NON-TRANSITORY COMPUTER-READABLE RECORDING MEDIUM, INFORMATION CONTROL METHOD, AND TERMINAL DEVICE

(71) Applicant: YAHOO JAPAN CORPORATION, Tokyo (JP)

(72) Inventor: Yoshiki SUGISAKI, Tokyo (JP)

(73) Assignee: YAHOO JAPAN CORPORATION, Tokyo (JP)

(21) Appl. No.: 16/116,340

(22) Filed: Aug. 29, 2018

(30) Foreign Application Priority Data
Oct. 20, 2017 (JP) 2017-204046

(51) Int. Cl. G06F 3/0488; G06F 3/0485

(52) U.S. Cl. CPC G06F 3/04883; G06F 2203/04806; G06F 2203/04808; G06F 3/0485

(57) ABSTRACT

A non-transitory computer-readable recording medium having stored therein an information control program that causes a computer to execute: determining whether predetermined operation of touching a display screen of a terminal device is performed and thereafter maintaining operation of maintaining a state, in which the display screen is touched as a result of performing the predetermined operation, is being performed; and controlling including continuing second change operation that is based on first change operation when it is determined, at the determining, that the maintaining operation is being performed, the first change operation being operation started in accordance with the predetermined operation and performed for changing predetermined information related to a content displayed on the display screen.

### CROSS-REFERENCE TO RELATED APPLICATION(S)

The present application claims priority to and incorporates by reference the entire contents of Japanese Patent Application No. 2017-204046 filed in Japan on Oct. 20, 2017.

### BACKGROUND OF THE INVENTION

### 1. Field of the Invention

The present invention relates to a computer-readable recording medium having stored therein an information control program, an information control method, and a terminal device.

### 2. Description of the Related Art

In recent years, terminal devices include touch panels that enable touch panel operation. With use of the touch panels, users can easily operate the terminal devices. For example, Japanese Laid-open Patent Publication No. 2015-64896 discloses a user can easily zoom in (enlarge) contents displayed on a screen by performing touch operation on a touch panel.

However, in the conventional technology as described above, it is not always possible to improve usability related to content display. For example, in the conventional technology as described above, when a touch-detected state is not maintained for a pre-set time or longer, and if operation of moving a touch position is detected while the touched state is maintained, image zooming is performed in accordance with the moved touch position and a zoomed image is displayed on the touch screen.

In the conventional technology as described above, for example, when a user wants to further zoom the zoomed image, the user needs to repeat operation of moving the touch position while maintaining the touched state, which is cumbersome. In addition, it is often the case that the user operates the terminal device in one hand. In this situation, if the user needs to repeat the above-described operation in an unstable state, such as a one-handed operation state, the user may feel stressed. In view of the foregoing situation, in the conventional technology, it is not always possible to ensure high usability related to content display.

### SUMMARY OF THE INVENTION

It is an object of the present invention to at least partially solve the problems in the conventional technology.

According to one aspect of an embodiment, An information control program includes determining whether predetermined operation of touching a display screen of a terminal device is performed and thereafter maintaining operation of maintaining a state, in which the display screen is touched as a result of performing the predetermined operation, is being performed. The information control program includes controlling including continuing second change operation that is based on first change operation when it is determined, at the determining, that the maintaining operation is being performed, the first change operation being operation started in accordance with the predetermined operation and performed for changing predetermined information related to a content displayed on the display screen.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of an information control process according to an embodiment;

FIG. 2 is a diagram illustrating a configuration example of an information control system according to the embodiment;

FIG. 3 is a diagram illustrating a configuration example of a terminal device according to the embodiment;

FIG. 4 is a flowchart illustrating an example of the information control process according to the embodiment;

FIG. 5 is a diagram illustrating an example of an information control process based on a hold position;

FIG. 6 is a diagram illustrating an example of a zoom switching process; and

FIG. 7 is a diagram illustrating a hardware configuration example of a computer that implements functions of the terminal device.

### DETAILED DESCRIPTION OF THE PREFERRED EMBODIMENTS

Modes (hereinafter, referred to as “embodiments”) for carrying out a computer-readable recording medium storing an information control program, an information control method, and a terminal device according to the present application will be described below with reference to the drawings. The computer-readable recording medium storing the information control program, the information control method, and the terminal device according to the present application are not limited by the embodiments below. In the following embodiments, the same components are denoted by the same reference signs, and the same explanation will be omitted.

### 1. Information Control Process

First, an overview of an information control process implemented by an information control program or the like according to the present application will be described below. In the following description, the overview of the information control process will be described by using operation of a terminal device 10, which is one example of an information control device of the present application, as an example.

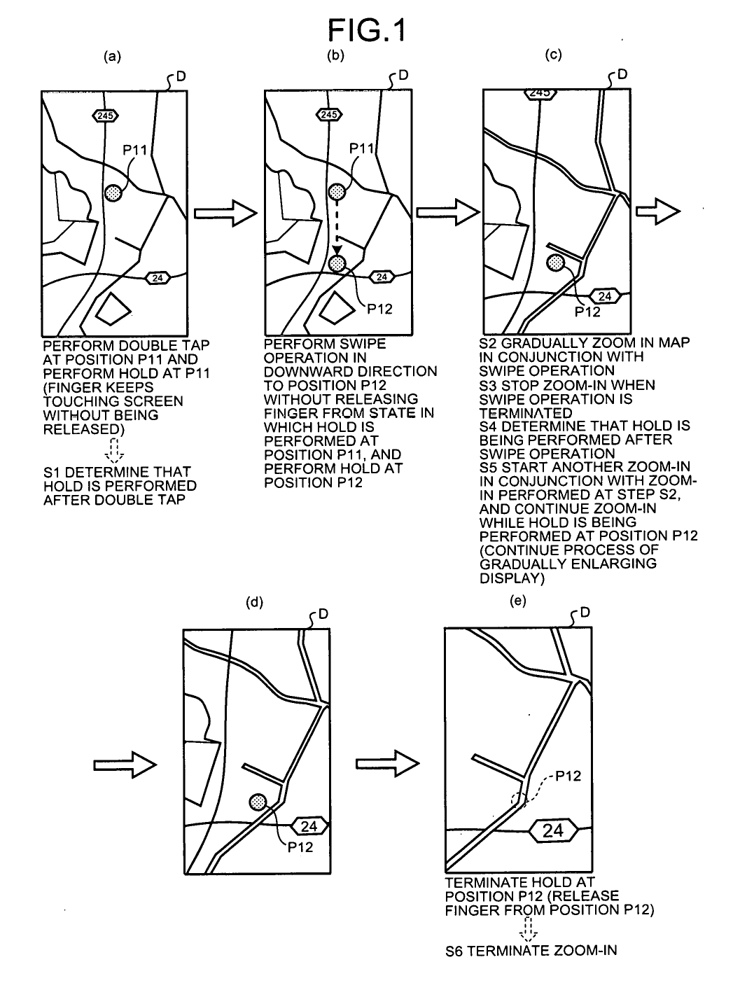

The terminal device 10 is an information processing apparatus used by a user. The terminal device 10 is, for example, a smartphone, a tablet terminal, a notebook personal computer (PC), a desktop PC, a mobile phone, a personal digital assistant (PDA), or the like. It is assumed that the terminal device 10 according to the embodiment is a smartphone. An output unit 14 of the terminal device 10 and an input unit that detects user's touch on a screen are integrated with each other and constitute a touch panel screen (a display screen D). In an example illustrated in FIG. 1, it is assumed that the terminal device 10 is used by a user U1.

It is further assumed that an information control program according to the embodiment functions as an application (hereinafter, referred to as a “map application AP”) that provides various kinds of map information (an example of contents) via the terminal device 10, for example. It is further assumed that the map application AP is installed in the terminal device 10 in advance. With this configuration, the terminal device 10 performs various kinds of information processing under the control of the information control program according to the embodiment.

For example, upon receiving input of regional information (for example, an address, a facility name, or the like), the terminal device 10 displays, on the display screen D, map information on surrounding areas with respect to the received regional information. Further, the terminal device 10 changes a display mode of the currently-displayed map information in accordance with various kinds of input operation that are input on the touch panel (for example, touch operation or swipe operation). As one example, the terminal device 10 zooms in (enlarges) or zooms out (reduces) the currently-displayed map information.

Specifically, the terminal device 10 determines whether predetermined operation of touching the display screen D is performed and thereafter maintaining operation of maintaining a state, in which the display screen D is touched as a result of performing the predetermined operation, is being performed, under the control of the information control program. If it is determined that the maintaining operation is being performed, the terminal device 10 continues second change operation that is based on first change operation, where the first change operation is started in accordance with the predetermined operation and performed for changing predetermined information related to a content displayed on the display screen D.

For example, the terminal device 10 determines whether operation (for example, swipe operation) of tracing the display screen D is performed as the predetermined operation in a state, in which the display screen D is touched as a result of performing touch operation (for example, double tap) of touching a certain single point on the display screen D a predetermined number of times, and thereafter maintaining operation (for example, hold) of maintaining a state, in which the display screen D is touched as a result of performing the predetermined operation, is being performed.

The maintaining operation is, for example, maintaining operation of maintaining a state, in which the display screen D is touched in a standstill manner at a certain position at which the display screen D is touched as a result of performing the predetermined operation. In the present embodiment, the maintaining operation of maintaining a state, in which the display screen D is touched with a finger as a result of performing input operation, such as the above-described predetermined operation, on the display screen D and in which the finger remains still without being released from the touched position (for example, when the display screen D is touched with a forefinger, the forefinger remains still without being released from the touched position), will be referred to as “hold”. In the following, an example of an information control process that is performed by the terminal device 10 under the control of the information control program will be described with reference to the example illustrated in FIG. 1. FIG. 1 is a diagram illustrating an example of the information control process according to the embodiment.

For example, it is assumed that the user U1 operates the terminal device 10 and activates the map application AP. In this case, the terminal device 10 acquires current location information indicating a current location of the own device (a current location of the user U1). For example, the terminal device 10 acquires the current location information using a global positioning system (GPS) function. Then, the terminal device 10 displays map information that is based on the acquired current location information on the display screen D. For example, the terminal device 10 displays, on the display screen D, map information that includes the current location and a surrounding area and that is provided at a predetermined scale level (for example, 1:5000). The map information illustrated in FIG. 1(a) is map information in the initial state, which is displayed in the manner as described above.

In the state illustrated in FIG. 1(a), the user U1 performs touch operation of touching an arbitrary position on the display screen D a predetermined number of times, that is, double tap, and performs hold at the arbitrary position at which the double tap is performed. The double tap indicates that the screen is successively touched twice; therefore, the user U1 performs hold that is to maintain a state, in which a finger remains still without being released from the arbitrary position that is a position at which the display screen D is touched by the second touch. In the example in FIG. 1(a), it is indicated that the user U1 performs double tap at a position P11 on the display screen D and then performs hold at the position P11. In this case, the terminal device 10 determines that the hold is performed, which is to maintain a state in which the display screen D is touched as a result of performing the touch operation (double tap) on the display screen D (Step S1).

Further, the user U1 performs operation (for example, swipe operation) of tracing the display screen D in a downward direction while touching the display screen D due to the hold as illustrated in FIG. 1(a), and stops the tracing operation at an arbitrary position on the display screen D. Furthermore, the user U1 performs hold at the arbitrary position at which the tracing operation is stopped. In the example in FIG. 1(b), it is indicated that the user U1 performs swipe operation to an arbitrary position P12 while touching the position P11 as a result of performing the double tap at the position P11, and then performs hold at the position P12 at which the swipe operation is stopped.

In response to the execution of the user operation as illustrated in FIG. 1(b), the terminal device 10 performs processes from Step S2 to Step S4. First, as illustrated in FIG. 1(c), the terminal device 10 starts zoom-in (an example of the first change operation), which is change operation of gradually enlarging the map information, in conjunction with the swipe operation (Step S2). The terminal device 10 stops the zoom-in when the swipe operation is terminated at the position P12 (Step S3). The terminal device 10 determines that the operation (swipe operation) of tracing the display screen D is performed in a state, in which the display screen D is touched as a result of performing the touch operation (double tap), and thereafter the hold (user operation in FIG. 1(b)) of maintaining a state, in which the display screen D is touched as a result of performing the tracing operation, is being performed (Step S4).

As a result of the determination at Step S4, the terminal device 10 starts another zoom-in (an example of the second change operation) that is similar to the zoom-in performed at Step S2, in conjunction with the zoom-in performed at Step S2, and continues the zoom-in while determining that the hold is being performed at the position P12 (Step S5). In other words, the terminal device 10 dynamically continues the zoom in while maintaining the determination at Step S4 (while the hold is maintained without change after the swipe operation) even when the user U1 does not perform the swipe operation. For example, the terminal device 10 continues the zoom-in in a stepwise manner as illustrated in FIG. 1(d) and FIG. 1(e) while the hold is maintained without change after the swipe operation.

Further, it is assumed that the user U1 terminates the hold when a state as illustrated in FIG. 1(e) is obtained by the zoom-in. The termination of the hold corresponds to termination of touch on the display screen. For example, in the example illustrated in FIG. 1(e), the termination indicates that the finger that has touched the position P12 on the display screen D is released from the display screen D. In this case, the terminal device 10 determines that the hold is terminated, and terminates the zoom-in that has been started at Step S5 and continued so far (Step S6).

As described above, the terminal device 10 according to the embodiment determines whether the hold is performed, which is to maintain a state in which the display screen D is touched in a standstill manner at a position at which the display screen D is touched as a result of performing the touch operation (double tap) on the display screen D, under the control of the information control program. If it is determined that the hold is performed, the terminal device 10 determines whether operation (swipe operation) of tracing the display screen D is performed in the state in which the display screen D is touched due to the hold, and another hold is performed to maintain a state, in which the display screen D is touched in a standstill manner at a position at which the tracing operation is terminated. If it is determined that the hold is performed after the swipe operation, the terminal device 10 further starts change operation (zoom-in) in conjunction with change operation (zoom-in) that has been started in accordance with the swipe operation. Then, the terminal device 10 continues the change operation (zoom-in) while the hold is maintained.

In this situation, for example, when double tap is used as a trigger and a user is allowed to zoom in the map information by performing swipe operation following hold after the double tap, in some cases, it is impossible for the user to zoom in the map information to a desired extent by single swipe operation. In this case, the user needs to repeat the swipe operation, which is cumbersome. In addition, it is often the case that the terminal device 10 is operated in one hand, and it is likely that the above-described operation is repeated through one-handed operation. When the one-handed operation is performed, the terminal device 10 is usually held in an unstable state, and the user who is forced to repeal operation in the unstable state may feel stressed.

In contrast, the terminal device 10 according to the embodiment continues zoom-in even when the swipe operation is not performed, as long as the hold is maintained without change after the swipe operation. Therefore, it is possible to eliminate the need of repetitions of operation as described above. As a result, the terminal device 10 is able to improve usability related to content display.

When swipe operation is performed in an upward direction in the state illustrated in FIG. 1(b), the terminal device 10 continues zoom-out (reduced display) on the map information. In other words, in the present embodiment, the terminal device 10 performs zoom-in in accordance with the swipe operation in the downward direction and performs zoom-out in accordance with the swipe operation in the upward direction. However, directions and trajectories of the swipe operation that causes the terminal device 10 to perform the change operation and types of the change operation to be performed by the terminal device 10 are not specifically limited.

### 2. Configuration of Information Control System

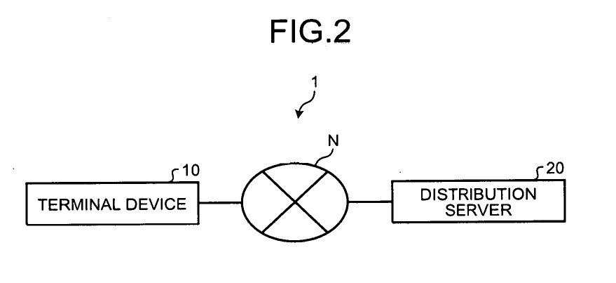

Next, a configuration of the information control system according to the embodiment will be described with reference to FIG. 2. FIG. 2 is a diagram illustrating a configuration example of an information control system 1 according to the embodiment. As illustrated in FIG. 2, the information control system 1 includes the terminal device 10 and a distribution server 20. The terminal device 10 and the distribution server 20 are communicably connected to each other via a network N in a wired or wireless manner. The information control system 1 illustrated in FIG. 1 may include a plurality of the terminal devices 10 or a plurality of the distribution servers 20.

The terminal device 10 performs the information control process illustrated in FIG. 1. In other words, the information control program according to the embodiment is installed, as the map application AP, in the terminal device 10, and causes the terminal device 10 to perform the information control process illustrated in FIG. 1.

The distribution server 20 distributes latest map information to the terminal device 10 in which the map application AP is installed, for example. Various kinds of information (for example, road information or facility information) included in the map information are changed day by day; therefore, the distribution server 20 periodically distributes the latest map information to the terminal device 10, for example. The distribution server 20 may distribute the map information when accessed by the terminal device 10.

### 3. Configuration of Terminal Device

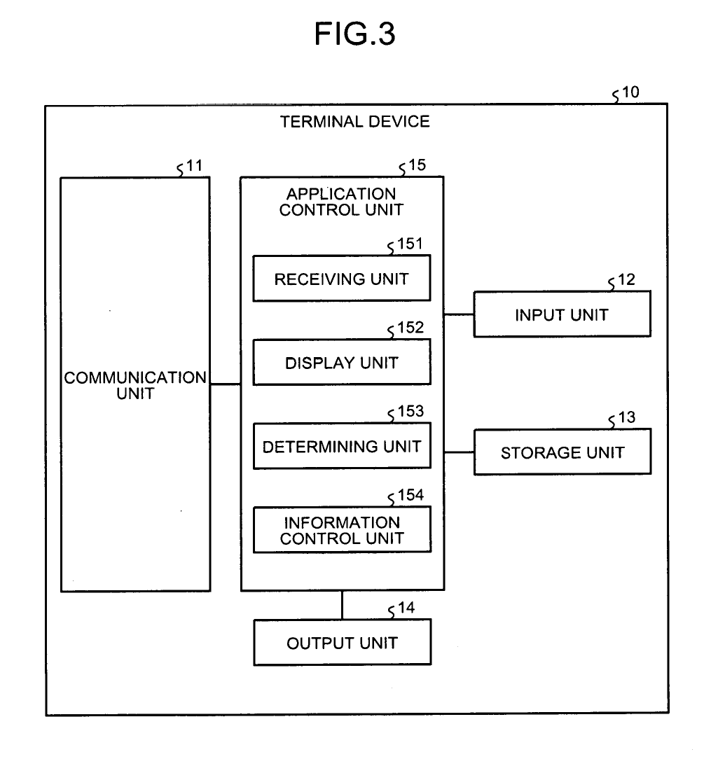

Next, the terminal device 10 according to the embodiment will be described with reference to FIG. 3. FIG. 3 is a diagram illustrating a configuration example of the terminal device 10 according to the embodiment. As illustrated in FIG. 3, the terminal device 10 includes a communication unit 11, an input unit 12, a storage unit 13, the output unit 14, and an application control unit 15.

Communication Unit 11

The communication unit 11 is realized by, for example, a network interface card (NIC) or the like. The communication unit 11 is connected to the network N in a wired or wireless manner, and transmits and receives information to and from the distribution server 20, for example.

Input Unit 12

The input unit 12 is an input device that receives various kinds of input from outside. For example, the input unit 12 is an operating device, such as a keyboard, a mouse, or an operation key, that allows a user to perform various kinds of operation. The input unit 12 functions as an input means of the terminal device 10. The input unit 12 includes a touch panel. In this case, the user performs various kinds of operation by touching a screen with a finger or a stylus. A pressure sensitive sensor is arranged in the touch panel included in the input unit 12. The input unit 12 is able to recognize pressing operation in addition to touch operation performed by the user.

Storage Unit 13

The storage unit 13 is a data readable/writable storage device, such as a dynamic random access memory (DRAM), a static random access memory (SRAM), a flash memory, or a hard disk. The storage unit 13 functions as a storage means of the terminal device 10. The storage unit 13 stores therein data of application software, such as a web browser. The user communicates with the distribution server 20 via the application software. For example, the storage unit 13 stores therein the map information distributed by the distribution server 20.

Output Unit 14

The output unit 14 is a device that provides various kinds of output, such as sound, light, oscillation, images, or the like, to the outside. The output unit 14 functions as an output means of the terminal device 10. The output unit 14 includes a display device that displays various kinds of information. The display device is, for example, a liquid crystal display or an organic electro luminescence (EL) display. The display device may be integrated with the input unit 12. As described above, the input unit 12 includes the touch panel in which the pressure sensitive sensor is arranged. In the present embodiment, it is assumed that the output unit 14 is a display that is integrated with the touch panel in which the pressure sensitive sensor is arranged. The output unit 14 displays an image on a screen (display) under the control of the application control unit 15. In the present embodiment, it is assumed that the output unit 14 corresponds to the display screen D.

Application Control Unit 15

The application control unit 15 is realized by causing a central processing unit (CPU) or a micro processing unit (MPU) to execute various programs stored in an internal storage device of the terminal device 10 by using a random access memory (RAM) as a work area. Further, the application control unit 15 is realized by, for example, an integrated circuit, such as an application specific integrated circuit (ASIC) or a field programmable gate array (FPGA). Furthermore, the application control unit 15 is a processing unit implemented by the information processing program according to the embodiment.

As illustrated in FIG. 3, the application control unit 15 includes a receiving unit 151, a display unit 152, a determining unit 153, and an information control unit 154, and implements or executes functions or effects of information processing to be described later. The internal configuration of the application control unit 15 is not limited to the configuration illustrated in FIG. 3, and other configurations may be applied as long as the information processing to be described later is performed. In addition, the connection relation of the processing units included in the application control unit 15 is not limited to the connection relation illustrated in FIG. 3, and any other connection relation may be adopted.

Receiving Unit 151

The receiving unit 151 receives contents. For example, the receiving unit 151 receives map information as a content distributed by the distribution server 20. Further, the receiving unit 151 stores the received content in the storage unit 13.

Display Unit 152

The display unit 152 displays the content on the display screen D that is the output unit 14. For example, the display unit 152 displays, on the output unit 14, a content for which information is controlled by the information control unit 154 as will be described later.

Determining Unit 153

The determining unit 153 determines whether predetermined operation of touching the display screen D of the terminal device 10 is performed and thereafter maintaining operation of maintaining a state, in which the display screen D is touched as a result of performing the predetermined operation, is being performed.

Specifically, the determining unit 153 determines whether predetermined operation including touch operation of pressing the display screen D is performed and thereafter maintaining operation of maintaining a state, in which the display screen D is touched as a result of performing the predetermined operation, is being performed. For example, the determining unit 153 determines whether predetermined operation including, as the touch operation, touch operation (for example, double tap) of successively touching the display screen D a predetermined number of times is performed, and thereafter maintaining operation of maintaining a state, in which the display screen D is touched as a result of performing the predetermined operation, is being performed. Further, the determining unit 153 determines whether predetermined operation including operation (for example, swipe operation or slide operation) of tracing the display screen D is performed, and thereafter maintaining operation of maintaining a state, in which the display screen D is touched as a result of performing the predetermined operation, is being performed.

In view of the example as described above, more specifically, the determining unit 153 determines whether operation of tracing the display screen D is performed as the predetermined operation in a state, in which the display screen D is touched as a result of performing the touch operation (for example, double tap), and thereafter maintaining operation of maintaining a state, in which the display screen D is touched as a result of performing the predetermined operation, is being performed. Further, the determining unit 153 determines whether maintaining operation (hold as illustrated in FIG. 1) of maintaining a state, in which the display screen D is touched in a standstill manner at a position at which the display screen D is touched as a result of performing the predetermined operation, is being performed as the maintaining operation.

Information Control Unit 154

When the determining unit 153 determines that the maintaining operation is being performed, the information control unit 154 continues the second change operation that is based on the first change operation, where the first change operation is started in accordance with the predetermined operation (operation of tracing the display screen D in a state, in which the display screen D is touched in a stand still manner as a result of performing the touch operation) and performed for changing predetermined information related to a content displayed on the display screen D. For example, when the determining unit 153 determines that the maintaining operation is being performed, the information control unit 154 continues, as the second change operation, change operation similar to the first change operation that is started in accordance with the predetermined operation as described above. For example, when the first change operation that is started in accordance with the predetermined operation as described above is zoom-in as in the example illustrated in FIG. 1, the information control unit 154 continues, as the second change operation, zoom-in similar to the zoom-in that has been performed as above.

Furthermore, when the determining unit 153 determines that the maintaining operation is being performed, the information control unit 154 starts the second change operation in conjunction with the first change operation, and continues the started second change operation while the maintaining operation is being performed. When the determining unit 153 determines that the maintaining operation is terminated, the information control unit 154 terminates the second change operation.

### 4. One Example of Functions and Effects in Information Control Process

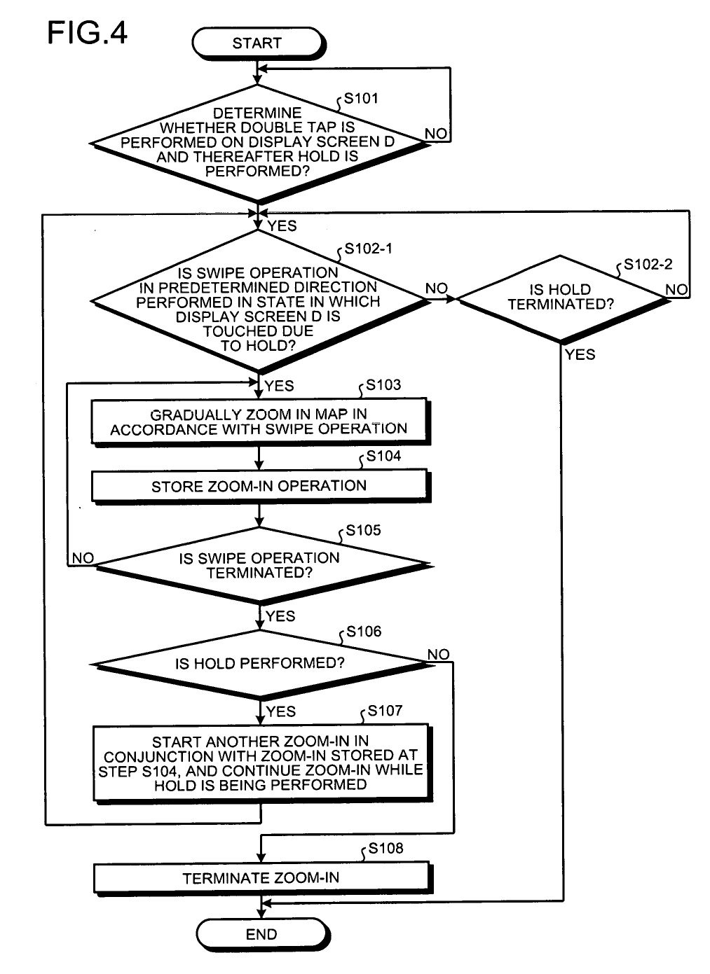

With reference to a flowchart illustrated in FIG. 4, details of processes executed and implemented by each of the processing units (in particular, the determining unit 153 and the information control unit 154) will be described below. FIG. 4 is a flowchart illustrating an example of an information control process according to the embodiment. The information control process illustrated in FIG. 4 is presented to explain details of the information control process illustrated in FIG. 1. Therefore, the example illustrated in FIG. 1 will be used appropriately.

In the example illustrated in FIG. 4, it is assumed that the information control program (the map application AP) according to the embodiment is installed in advance in the terminal device 10 of the user U1. It is further assumed that the map information is displayed on the display screen D by activating the map application AP as illustrated in FIG. 1(a).

In this state, the determining unit 153 determines whether the double tap is performed on the display screen D, and a state in which the display screen D is touched in a stand still manner at a position at which the double tap is performed (for example, a position touched by the second touch operation of two successive operations) is maintained, that is, whether hold is performed (Step S101). If the determining unit 153 determines that the hold is not performed (Step S101; No), the determining unit 153 waits until the hold is performed following the double tap. In contrast, as illustrated in FIG. 1(a) for example, it is assumed that the user U1 performs double tap at the position P11 on the display screen D and performs hold at the position P11. In this case, the determining unit 153 determines that the hold is performed following the double tap (Step S101; Yes).

If the determining unit 153 determines that the hold is performed following the double tap (Step S101; Yes), the determining unit 153 determines whether operation of tracing the display screen D in a predetermined direction, that is, swipe operation, is performed in a state, in which the display screen D is touched due to the hold (Step S102-If the determining unit 153 determines that the swipe operation is not performed following the hold (Step S102-1; No), the determining unit 153 determines whether the hold is terminated (Step S102-2). Termination of the hold corresponds to, for example, termination of touch on the display screen D. While the determining unit 153 continues to determine that the hold is not terminated (while the hold at the position P11 is being performed) (Step S102-2; No), the determining unit 153 continues the determination process at Step S102-1. In contrast, if the determining unit 153 determines that the hold is terminated (Step S102-2; Yes), the process ends.

Referring back to the example of the flowchart, it is assumed that the user U1 performs swipe operation in a downward direction while performing the hold at the position P11 as illustrated in FIG. 1(b), for example. In this case, the determining unit 153 determines that the swipe operation in the downward direction is performed following the hold (Step S102-1; Yes).

If it is determined that the swipe operation in the downward direction is performed following the hold (Step S102-1; Yes), the information control unit 154 starts zoom-in (an example of the first change operation), which is change operation of gradually enlarging the map information, in conjunction with the swipe operation while the swipe operation, is being performed (Step S103). If it is determined that swipe operation in an upward direction is performed following the hold, the information control unit 154 starts zoom-out (an example of the first change operation), which is change operation of gradually reducing the map information, in conjunction with the swipe operation while the swipe operation, is being performed. Further, the determining unit 153 stores the zoom-in that is the first change operation started at Step S103 (Step S104). For example, the determining unit 153 stores information indicating that the zoom-in is performed at Step S103.

Subsequently, if the determining unit 153 determines that the swipe operation is performed at Step S102-1, the determining unit 153 determines whether the swipe operation is terminated while the swipe operation, is being performed (Step S105). If the swipe operation is not terminated (Step S105; No), the determining unit 153 continues the processes from Step S103. In contrast, it is assumed that the user U1 has terminated the swipe operation, which is started at the position P11 on the display screen D, at the position P12 as illustrated in FIG. 1(b), for example. In this case, the determining unit 153 determines that the swipe operation is terminated (Step S105; Yes). For example, when a finger, which has been moved by the swipe operation while being in contact with the display screen D, is stopped while being in contact with the display screen D, the determining unit 153 determines that the swipe operation is terminated. Further, while not illustrated in the drawings, if it is determined that the swipe operation is terminated, the information control unit 154 terminates the zoom-in started at Step S103 (an example of the first change operation).

Furthermore, if the determining unit 153 determines that the swipe operation is terminated (Step S105; Yes), the determining unit 153 determines whether a state, in which the display screen D is touched as a result of the swipe operation in a standstill manner at a position at which the swipe operation is terminated, is maintained, that is, whether the hold is performed (Step S106). If the determining unit 153 determines that the hold is not performed (Step S106; No), the determining unit 153 terminates the zoom-in (Step S108). In contrast, it is assumed that the user U1 has performed the hold at the position P12 as illustrated in FIG. 1(b), for example. In this case, the determining unit 153 determines that the hold is performed, which is to maintain a state in which the display screen D is touched in a stand still manner after performing operation (swipe operation) of tracing the display screen D in a state in which the display screen D is touched as a result of performing the touch operation (double tap) (Step S106; Yes).

Subsequently, if it is determined that the hold is performed following the swipe operation (Step S106; Yes), the information control unit 154 starts another zoom-in (an example of the second change operation) that is similar to the zoom-in stored at Step S104, in conjunction with the zoom-in that is the first change operation stored at Step S104, and continues the zoom-in while determining that the hold is being performed at Step S106 (Step S107). Further, while the information control unit 154 continues the zoom-in during the hold, the determining unit 153 returns to the determination process starting from Step S102-1. For example, while the information control unit 154 continues the zoom-in Miring the hold, the determining unit 153 determines whether the direction of the swipe operation is changed from the current direction (the downward direction) to a different direction (for example, the upward direction). This case will be described in a section “5-2” of a modification to be detail later.

If it is determined that the swipe operation is terminated at Step S105, the information control unit 154 temporarily stops the zoom-in (an example of the first change operation); however, because another zoom-in (an example of the second change operation) is performed at Step S107 in conjunction with the former zoom-in (an example of the first change operation), the zoom-in operations are perceived as continuous zoom-in by the user U1.

At Step S106, the determining unit 153 determines whether the hold is terminated in addition to determining that the hold is being performed while the user U1 continues the hold following the swipe operation. If the hold that has been continuously performed is terminated, the determining unit 153 terminates the zoom-in that has been performed so far (Step S108).

### 5. Modification

The information control program according to the embodiment described above may be configured to control the terminal device 10 such that the terminal device 10 performs various different processes other than the processes described in the embodiment above. Therefore, other embodiments of the terminal device 10 operated by the information control program will be described below.

### 5-1. Zoom Focusing on Hold Position

When the determining unit 153 determines that the maintaining operation is being performed, the information control unit 154 starts the second change operation in conjunction with the first change operation, which is started in accordance with the predetermined operation and which is performed while focusing on the position at which the maintaining operation included in the predetermined operation is performed, and continues the started second change operation while the maintaining operation is being performed. For example, the information control unit 154 starts zoom-in or zoom-out in conjunction with zoom-in or zoom-out that is performed with a focus on the position at which the maintaining operation included in the predetermined operation is performed, and continues the started zoom-in or zoom out while the maintaining operation is being performed.

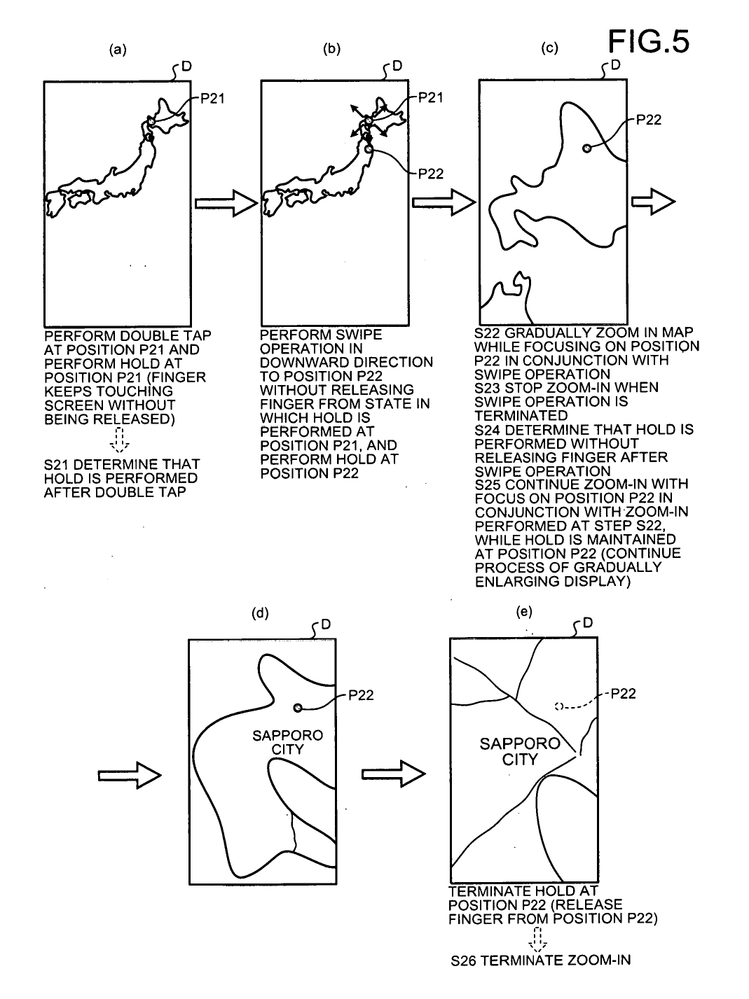

In the example described above, it is explained that the predetermined operation is the operation (swipe operation in the example illustrated in FIG. 1) of tracing the display screen D in a state, in which the display screen D is touched as a result of performing the touch operation (double tap in the example illustrated in FIG. 1). Further, the predetermined operation includes two kinds of maintaining operation. One of the two kinds of maintaining operation is hold to maintain a state, in which the display screen D is touched as a result of performing the touch operation (double tap in the example illustrated in in FIG. 1), and this hold is a target of the determination at Step S101 in the example in FIG. 4. One example of the modification using this hold will be described below using an example illustrated in FIG. 5.

FIG. 5 is a diagram illustrating an example of an information control process based on a hold position. In the present modification, basic operation of the terminal device 10 is the same as the operation described above with reference to FIG. 1, and therefore, the same explanation will be omitted.

In a state illustrated in FIG. 5(a), it is assumed that the user U1 wants to view a map in which “Sapporo city” and a surrounding area are enlarged. In this case, the user U1 performs double tap at a position P21 where “Sapporo city” is located on the display screen D, and performs hold at the position P21. In this case, the determining unit 153 determines that the hold is performed to maintain a state, in which the display screen D is touched as a result of performing the double tap at the position P21 on the display screen D (Step S21).

Further, the user U1 performs swipe operation in a downward direction while touching the display screen D due to the hold as illustrated in FIG. 5(a), and stops the swipe operation at an arbitrary position on the display screen D. Furthermore, the user U1 performs hold at the arbitrary position at which the swipe operation is stopped. In the example illustrated in FIG. 5(b), the user U1 performs swipe operation to a certain position P22 while touching the position P21 in a standstill manner as a result of performing the double tap at the position P21, and performs the hold at the position P22 at which the swipe operation is stopped.

The terminal device 10 performs processes from Step S22 to Step S24 in response to the execution of the user operation as illustrated in FIG. 5(b). First, as illustrated in FIG. 5(c), the information control unit 154 starts zoom-in (an example of the first change operation) for gradually enlarging the map information while focusing on the position P21 on the display screen D at which the hold is performed as a result of the double tap (while focusing on the position P21 indicating “Sapporo city”), in conjunction with the swipe operation (Step S22). Further, the information control unit 154 stops the zoom-in when the swipe operation is terminated at the position P22 (Step S23). Furthermore, the determining unit 153 determines that the hold (user operation in FIG. 5(b)) is performed, which is to maintain a state in which the display screen D is touched as a result of the swipe operation after the swipe operation is performed while the display screen D is touched as a result of performing the double tap (Step S24).

As a result of the determination at Step S24, the information control unit 154 starts another zoom-in (an example of the second change operation) that is similar to the zoom-in performed at Step S22, in conjunction with the zoom-in performed at Step S22, and continues the zoom-in while determining that the hold is being performed at the position P22 (Step S25). In other words, the information control unit 154 continues the zoom-in while focusing on the position P21. For example, the information control unit 154 continues the zoom-in in a stepwise manner with a focus on the position P21 as illustrated in FIG. 5(d) to FIG. 5(e) while the hold is maintained without change after the swipe operation.

Furthermore, it is assumed that the user U1 terminates the hold when the state as illustrated in FIG. 5(e) is obtained by the zoom-in. In this case, in response to the determination that the hold is terminated, the information control unit 154 terminates the zoom-in that has been started at Step S25 and continued so far (Step S26).

In this manner, the information processing program according to the embodiment causes the terminal device 10 to perform change operation focusing on the hold position when the hold is performed at the position at which the touch operation (for example, double tap) is performed. With this configuration, the information processing program according to the embodiment is able to provide an enlarged view, in which a position that the user wants to enlarge is enlarged, so that it is possible to improve usability related to content display.

In the present modification, the example has been described in which the zoom-in is continued while focusing on the position at which the first maintaining operation is performed between the two kinds of maintaining operation included in the predetermined operation. However, when hold as the second maintaining operation, that is, the maintaining operation caused by the swipe operation following the double tap, is performed, the terminal device 10 may continue zoom-in while focusing on a position at which the hold is being performed, under the control of the information processing program. This hold is a target of the determination at Step S105 in the example in FIG. 4.

In this case, when the user U1 wants to view a map in which “Sapporo city” and a surrounding area are enlarged, the user U1 performs double tap and hold at an arbitrary position located above the position P21 on the display screen D, and performs swipe operation from the hold position to the position P21. Then, the user U1 terminates the swipe at the position P21 and performs the hold without change. In response to the user operation as described above, the terminal device 10 starts zoom-in focusing on the position P21, in conjunction with the zoom-in that has been performed in accordance with the swipe operation.

While the zoom-in is explained as the example in the present modification, the terminal device 10 may perform zoom-out focusing on the hold position.

### 5-2. Change of Zoom

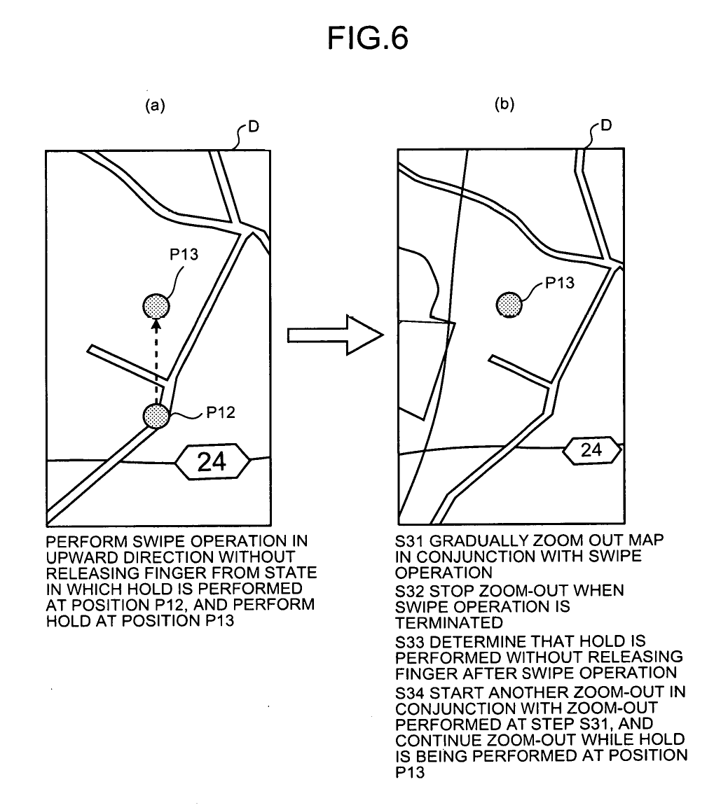

When the maintaining operation is changed to predetermined operation while the second change operation is continued, the information control unit 154 changes the second change operation to different change operation that is based on the second change operation. As described above, when the hold is performed following the swipe operation in the downward direction by using the double tap as a trigger, the information control unit 154 continues zoom-in (the second change operation), which is similar to the zoom-in serving as the first change operation, while the hold is being performed. If the user changes the swipe operation to swipe operation in the upward direction (an example of the predetermined operation) while the zoom-in serving as the second change operation is continued, that is, while it is determined that the hold is being performed by the user, the information control unit 154 changes the zoom-in operation to zoom-out operation (an example of the change operation that is based on the second change operation). This case will be described below using an example illustrated in FIG. 6.

FIG. 6 is a diagram illustrating an example of a zoom switching process. FIG. 6(a) corresponds to FIG. 1(e). Further, FIG. 6(a) illustrates map information that has been zoomed in by the information control unit 154 because the hold as illustrated in FIG. 1(b) is continued by the user U1. In this state, it is assumed that the user U1 performs swipe operation in the upward direction (an example of the predetermined operation) while touching the display screen D from the state in which the hold is performed at the position P12, terminates the swipe operation at a position P13, and performs hold at the position P13. As illustrated in FIG. 1(b), the user U1 has performed the swipe operation in the downward direction from the position P11, as the swipe operation toward the position P12.

In response to the execution of the user operation as illustrated in FIG. 6(a), the terminal device 10 performs processes from Step S32 to Step S33. First, as illustrated in FIG. 6(b), the information control unit 154 changes the zoom-in operation that has been continued so far to zoom-out operation (the change operation that is based on the second change operation) for gradually reducing the map information, in conjunction with the swipe operation (Step S31). Further, the information control unit 154 stops the zoom-out when the swipe operation is terminated at the position P13 (Step S32). Furthermore, the determining unit 153 determines that the hold is performed at the position P13 (Step S33).

As a result of the determination at Step S33, the information control unit 154 starts another zoom-out that is similar to the zoom-out performed at Step S31, in conjunction with the zoom-out performed at Step S33, and continues the zoom-out while determining that the hold is being performed at the position P13 (Step S34).

As described above, the information processing program according to the embodiment causes the terminal device 10 to switch the change operation when the maintaining operation is changed to the predetermined operation. With this configuration, for example, even when the change operation on the content is being performed automatically, the information processing program according to the embodiment is able to instantly switch to change operation corresponding to user operation when the user operation is performed. Therefore, it is possible to improve usability related to content display.

### 5-3. Zoom According to Operation Speed

The information control unit 154 performs the second change operation at a speed corresponding to an operation speed at which the predetermined operation has been performed. Specifically, if it is determined that operation of tracing the display screen D is performed as the predetermined operation in a state, in which the display screen D is touched as a result of performing touch operation of pressing the display screen D, and thereafter maintaining operation of maintaining a state, in which the display screen D is touched as a result of performing the predetermined operation, is being performed, the information control unit 154 performs the second change operation at a speed corresponding to an operation speed of the tracing operation.

As one example, if it is determined that the swipe operation is performed and thereafter the hold is performed without change, the information control unit 154 starts zoom-in (an example of the second change operation) at a speed corresponding to a speed of the swipe operation, in conjunction with zoom-in (an example of the first change operation) that is started in accordance with the swipe operation. The zoom-in (an example of the first change operation) that is started in accordance with the swipe operation may also be performed in accordance with the speed of the swipe operation. Further, the information control unit 154 is able to perform zoom-out in accordance with the speed of the swipe operation.

With this configuration, the information processing program according to the embodiment is able to cause the terminal device 10 to perform the change operation in accordance with the operation speed of the user operation. Therefore, it is possible to improve usability.

### 5-4. Zoom According to Operation Strength

The information control unit 154 performs the second change operation at a speed corresponding to strength with which the display screen D is touched in the maintaining operation. This case will be described below using the example illustrated in FIG. 4. For example, when the determining unit 153 determines that the hold is performed at Step S105, the determining unit 153 detects strength with which the display screen D is pressed due to the hold. The strength may be detected by a processing unit other than the determining unit 153. Here, an example will be described in which three sensitivities such as “weak”, “moderate”, and “strong” are used as sensitivities (detection sensitivities) for detecting the strength with which the display screen D is pressed.

For example, it is assumed that the determining unit 153 detects the sensitivity of “moderate” based on the strength with which the display screen D is pressed due to the hold. In this case, the determining unit 153 instructs the information control unit 154 to perform zoom-in at a default speed (a basic speed set in advance). In response to the instruction, the information control unit 154 starts zoom-in (an example of the second change operation) at the default speed, in conjunction with zoom-in (an example of the first change operation) that is started in accordance with the swipe operation.

For another example, upon receiving, from the determining unit 153, an instruction to perform zoom-in at a predetermined speed faster than the default speed because of detection of the sensitivity of “strong”, the information control unit 154 starts zoom-in (an example of the second change operation) at the predetermined speed, in conjunction with zoom-in (an example of the first change operation) that is started in accordance with the swipe operation.

Even when the user continues the hold, the user may change the strength for pressing the display screen D during the hold. For example, it is assumed that the user U1 presses the display screen with the strength corresponding to the sensitivity of “moderate”, and thereafter changes the strength to a certain strength corresponding to the sensitivity of “strong” and continues the hold. The determining unit 153 further determines whether the pressing strength is changed during the hold. With this configuration, in the example as described above, the determining unit 153 detects the change from the sensitivity of “moderate” to the sensitivity of “strong”, and instructs the information control unit 154 to change the zoom-in that has been performed at the default speed to zoom-in to be performed at the predetermined speed that is faster than the default speed. In response to the instruction, the information control unit 154 changes the zoom-in that has been performed at the default speed to the zoom-in to be performed at the predetermined speed that is faster than the default speed.

With this configuration, the information processing program according to the embodiment is able to cause the terminal device 10 to perform the change operation at a speed corresponding to the strength of the maintaining operation performed by the user. Therefore, it is possible to improve usability related to content display.

### 5-5. Sensitivity Correction

The information control unit 154 starts the second change operation on the basis of a mode in which the display screen D is touched due to the maintaining operation. This case will be described below using the example illustrated in FIG. 4. For example, when the determining unit 153 determines that the hold is performed at Step S105, the determining unit 153 detects movement of the contact as the mode in which the display screen D is touched due to the hold. For example, it is assumed that the user U1 performs the hold with a forefinger. In this case, the determining unit 153 determines movement of the forefinger touching the display screen D, as the mode in which the display screen D is touched due to the hold performed with the forefinger. The movement in this case indicates the amount of movement between the hold position, at which it has been determined that the hold is performed (the position P12 in the example illustrated in FIG. 1), to a contact position of the forefinger.

For example, in some cases, the user may unintentionally move a finger although the user is attempting to perform the hold without moving the finger at the completely same position. In addition, in view of the structure of the human body, in some cases, the user may be unable to perform the hold without moving the finger at the completely same position. In other words, it is likely that the hold position may be changed from the hold position at which the hold is first performed, due to the hand movement.

If the change in the hold position as described above is recognized as the swipe operation for example, zoom that is not desired by the user may be started, for example. To prevent the situation as described above, the determining unit 153 detects movement of the contact as the mode in which the display screen D is touched due to the hold. Specifically, the determining unit 153 calculates, during the hold, the amount of movement of the hold position from the hold position (the position P12 in the example illustrated in FIG. 1) at which it has been determined that the hold is performed. For example, if the calculated moving distance is shorter than a predetermined distance, the determining unit 153 determines that the movement of the finger due to a change in the hold position corresponds to hand movement. In contrast, if the calculated moving distance is longer than the predetermined distance, the determining unit 153 determines that the movement of the finger due to a change in the hold position corresponds to swipe operation, for example.

Further, the determining unit 153 determines that the hold is being performed by the user U1 while determining that the movement is the hand movement, and instructs the information control unit 154 to continue the second change operation while the determination is maintained. In response to the instruction, the information control unit 154 is able to start the second change operation and continue the started second change operation, on the basis of the mode in which the display screen is touched due to the maintaining operation.

Furthermore, the information processing program according to the embodiment is able to cause the terminal device 10 to determine whether movement is hand movement or not. Therefore, for example, it is possible to prevent a situation in which a behavior that is not desired by the user and that is related to contents display occurs.

### 5-6. Various Kinds of Change Operation

In the embodiment described above, the example has been described in which the terminal device 10 performs zoom (zoom-in and zoom-out) as the change operation in accordance with the information control program.

Specifically, the example has been described in which when the terminal device 10 determines that operation (swipe operation) of tracing the display screen D is performed from a hold state in which hold is performed while the display screen D is touched as a result of performing touch operation (double tap), and thereafter another hold is performed while the display screen is touched as a result of the tracing operation, the terminal device 10 starts zoom-in (or zoom-out) in conjunction with zoom-in (or zoom-out) that has been performed so far. Further, the example has been described in which the terminal device 10 continues zoom-in (or zoom-out) while the hold is being performed.

However, the second change operation is not limited to zoom-in (or zoom-out) (the same applies to the first change operation). For example, the second change operation may be various kinds of change operation, such as scroll for moving a display position of a content in accordance with user operation (for example, swipe operation or the like), rotational display for rotating a content in accordance with user operation (for example, swipe operation or the like), change operation of changing brightness for displaying a content (luminance change), change operation of changing contrast (definition) for displaying a content (contrast change), change operation of changing a display mode of a content from two-dimensional display to three-dimensional display, or change operation of changing the display mode of a content from three-dimensional display to two-dimensional display (the same applies to the first change operation).

### 5-7. Scroll as Change Operation

If it is determined that swipe operation is performed from a hold state in which hold is performed while the display screen D is touched as a result of performing double tap, and thereafter another hold is performed while the display screen D is touched as a result of the swipe operation, the information control unit 154 starts scroll in conjunction with scroll that has been performed so far.

First, the user U1 performs touch operation of touching an arbitrary position on the display screen D a predetermined number of times, that is, double tap, and performs hold at the arbitrary position at which the double tap is performed. For example, it is assumed that the user U1 performs double tap at a position P41 on the display screen D, and performs hold at the position P41. In this case, the determining unit 153 determines that the hold is performed.

Further, the user U1 performs swipe operation while touching the display screen D due to the hold at the position P41, and stops the swipe operation at an arbitrary position on the display screen D. Furthermore, the user U1 performs hold at the arbitrary position at which the swipe operation is stopped. In this example, it is assumed that the user U1 performs swipe operation in a lower left direction while touching the position P41 due to the hold at the position P41, and stops the swipe operation and performs the hold at a position P42.

In response to the execution of the swipe operation as described above, the terminal device 10 performs a process as described below. The information control unit 154 starts scroll (an example of the first change operation) for moving the map information in the lower left direction, in conjunction with the swipe operation in the lower left direction. In the examples described above, it is explained that the information control unit 154 performs zoom-in at this time point; however, the information control unit 154 in this case scrolls the map information instead of the zoom-in. With this scroll, map information that has not been displayed on the display screen D and located in an upper right direction on the display screen D is displayed on the display screen D. Further, the information control unit 154 stops the scroll in the lower left direction when the swipe operation is terminated at the position P42. Furthermore, the determining unit 153 determines that the hold is performed following the swipe operation after the swipe operation is performed in a state, in which the display screen D is touched as a result of performing the hold while maintaining the double tap.

As a result of the determination that the hold is performed as described above, the information control unit 154 starts another scroll in a lower left direction (an example of the second change operation), in conjunction with the scroll that has been performed in the lower left direction (an example of the first change operation), and continues the scroll in the lower left direction while determining that the hold is being performed at the position P42. Further, when the user U1 terminates the hold at the position P42, the information control unit 154 terminates the scroll that has been continued so far.

As described above, the information processing program according to the embodiment is able to cope with scroll in addition to enlargement and reduction of contents. Therefore, it is possible to improve usability related to content display.

Further, while a process for a case in which enlargement and reduction of contents are replaced with scroll has been described in the present modification, it may be possible to adopt other kinds of change operation instead of enlargement, reduction, and scroll. As described above, the change operation may be rotational display, luminance change, contrast (definition) change, switch between two-dimensional display and three-dimensional display, or the like.

### 5-8. User Operation

In the embodiment described above, the touch operation (in particular, double tap) is explained as an example of the user operation (trigger) that causes the terminal device 10 to perform a certain process, such as a process of starting the second change operation in conjunction with the first change operation and continuing the second change operation while the hold is being performed. However, the touch operation is not limited to the double tap as long as the display screen D is touched. For example, single touch operation (single tap) or three successive touch operations (triple tap) may be adopted. For another example, single tap, double dap, and triple tap with two fingers may be adopted.

Further, in the embodiment described above, the example has been described in which the terminal device 10 performs, as the user operation, the first change operation in accordance with the swipe operation (in particular, swipe operation in a straight-line trajectory). However, the trajectory of the trace in the user operation is not specifically limited as long as the user operation is operation of tracing the display screen D. For example, in some cases, the user performs input operation on the display screen D with a user's thumb, and the input operation with the thumb is usually performed so as to draw an arc centered at the base of the thumb. Therefore, the user operation may be operation of tracing the display screen D so as to draw an arc. Furthermore, the user operation may be operation of drawing a circle in a clockwise direction (or in a counterclockwise direction).

### 6. Hardware Configuration

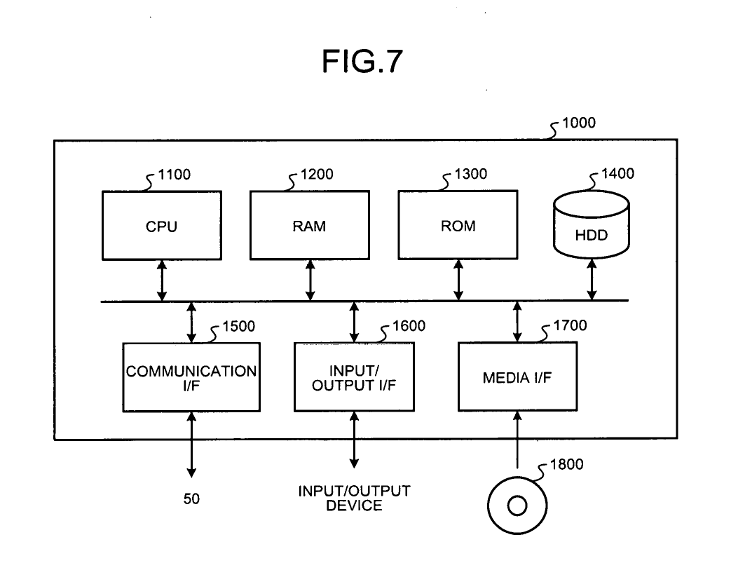

The terminal device 10 according to the embodiment as described above is realized by a computer 1000 configured as illustrated in FIG. 7, for example. FIG. 7 is a diagram illustrating a hardware configuration example of the computer 1000 that implements functions of the terminal device 10. The computer 1000 includes a CPU 1100, a RAM 1200, a read only memory (ROM) 1300, a hard disk drive (HDD) 1400, a communication interface (I/F) 1500, an input output I/F 1600, and a media I/F 1700.

The CPU 1100 operates based on programs stored in the ROM 1300 or the HDD 1400, and controls each of the units. The ROM 1300 stores therein a boot program, which is executed by the CPU 1100 at the time of activation of the computer 1000, a program that depends on the hardware of the computer 1000, or the like.

The HDD 1400 stores therein a program executed by the CPU 1100 and data or the like used by the program. The communication I/F 1500 receives data from other devices via a communication network 50, sends the data to the CPU 1100, and transmits data generated by the CPU 1100 to other devices via the communication network 50.

The CPU 1100 controls an output device, such as a display or a printer, and an input device, such as a keyboard or a mouse, via the input output I/F 1600. The CPU 1100 acquires data from the input device via the input output I/F 1600. Further, the CPU 1100 outputs generated data to the output device via the input output I/F 1600.

The media I/F 1700 reads a program or data stored in a recording medium 1800, and provides the program or the data to the CPU 1100 via the RAM 1200. The CPU 1100 loads the program from the recording medium 1800 onto the RAM 1200 via the media I/F 1700, and executes the loaded program. The recording medium 1800 is, for example, an optical recording medium, such as a digital versatile disc (DVD) or a phase change rewritable disk (PD), a magneto-optical recording medium, such as a magneto-optical disk (MO), a tape medium, a magnetic recording medium, a semiconductor memory, or the like.

For example, when the computer 1000 functions as the terminal device 10 according to the embodiment, the CPU 1100 of the computer 1000 executes the program loaded on the RAM 1200, and implements the functions of the control unit 15. Further, data stored in the storage unit 13 is stored in the HDD 1400. The CPU 1100 of the computer 1000 reads the programs from the recording medium 1800 and executes the programs. As another example, it may be possible to acquire the programs from other devices via the communication network 50.

### 7. Others

Of the processes described in the embodiments, all or part of a process described as being performed automatically may also be performed manually. Alternatively, all or part of a process described as being performed manually may also be performed automatically by known methods. In addition, the processing procedures, specific names, and information including various kinds of data and parameters illustrated in the above-described document and drawings may be arbitrarily changed unless otherwise specified.

In addition, the components of the apparatuses illustrated in the drawings are functionally conceptual and do not necessarily have to be physically configured in the manner illustrated in the drawings. In other words, specific forms of distribution and integration of the apparatuses are not limited to those illustrated in the drawings, and all or part of the apparatuses may be functionally or physically distributed or integrated in arbitrary units depending on various loads or use conditions.

Furthermore, the embodiments described above may be arbitrarily combined as long as the processes do not conflict with each other.

### 8. Effect

The terminal device 10 according to the embodiment performs the process as described below, under the control of the information control program. The terminal device 10 determines whether predetermined operation of touching the display screen is performed and thereafter maintaining operation of maintaining a state, in which the display screen is touched as a result of performing the predetermined operation, is being performed. If the terminal device 10 determines that the maintaining operation is being performed, the terminal device 10 continues the second change operation that is based on the first change operation, where the first change operation is started in accordance with the predetermined operation and performed for changing predetermined information related to a content displayed on the display screen. With this configuration, the terminal device 10 according to the embodiment is able to improve usability related to content display.

Furthermore, the terminal device 10 according to the embodiment determines whether the predetermined operation including touch operation of pressing the display screen is performed and thereafter maintaining operation of maintaining a state, in which the display screen is touched as a result of performing the predetermined operation, is being performed. With this configuration, the terminal device 10 according to the embodiment is able to display a content by using the touch Operation of pressing the display screen as a trigger.

Moreover, the terminal device 10 according to the embodiment determines whether the predetermined operation including, as the touch operation, touch operation of successively pressing the display screen a predetermined number of times is performed and thereafter maintaining operation of maintaining a state, in which the display screen is touched as a result of performing the predetermined operation, is being performed. With this configuration, the terminal device 10 according to the embodiment is able to display a content starting from the touch operation of pressing the display screen.

Furthermore, the terminal device 10 according to the embodiment determines whether the predetermined operation including operation of tracing the display screen is performed and thereafter maintaining operation of maintaining a state, in which the display screen is touched as a result of performing the predetermined operation, is being performed. With this configuration, the terminal device 10 according to the embodiment is able to perform change operation of changing a display mode of a content in accordance with the operation of tracing the display screen.

Moreover, the terminal device 10 according to the embodiment determines whether operation of tracing the display screen is performed as the predetermined operation in a state, in which the display screen is touched in a standstill manner as a result of performing the touch operation, and thereafter maintaining operation of maintaining a state, in which the display screen is touched as a result of performing the predetermined operation, is being performed. With this configuration, the terminal device 10 according to the embodiment is able to determine whether to perform the second change operation from simple and easy input operation performed by the user.

Furthermore, the terminal device 10 according to the embodiment determines whether maintaining operation of maintaining a state, in which the display screen is touched in a standstill manner at a position at which the display screen is touched as a result of performing the predetermined operation, is being performed as the maintaining operation. With this configuration, the terminal device 10 according to the embodiment is able to determine whether to perform the second change operation from simple and easy input operation performed by the user.

Moreover, when it is determined that the maintaining operation is being performed, the terminal device 10 according to the embodiment continues, as the second change operation, change operation that is similar to the first change operation that is started in accordance with the predetermined operation. With this configuration, the terminal device 10 according to the embodiment is able to prevent change operation that is not intended by the user from being performed.

Furthermore, when it is determined that the maintaining operation is being performed, the terminal device 10 according to the embodiment starts the second change operation in conjunction with the first change operation, and continues the started second change operation while the maintaining operation is being performed. With this configuration, the terminal device 10 according to the embodiment is able to dynamically continue the second change operation without requesting the user to repeat input operation, for example. Therefore, it is possible to improve usability related to content display.

Moreover, the terminal device 10 according to the embodiment starts the second change operation on the basis of a mode in which the display screen is touched due to the maintaining operation. With this configuration, the terminal device 10 according to the embodiment is able to determine whether the mode in which the display screen is touched due to the maintaining operation corresponds to hand movement or not. Therefore, it is possible to prevent occurrence of a behavior that is not intended by the user.

Furthermore, when it is determined that the maintaining operation is terminated, the terminal device 10 according to the embodiment terminates the second change operation. With this configuration, the terminal device 10 according to the embodiment is able to stop the second change operation in accordance with user operation even when the second change operation is dynamically continued.

Moreover, the terminal device 10 according to the embodiment performs the second change operation at a speed corresponding to an operation speed at which the predetermined operation has been performed. With this configuration, the terminal device 10 according to the embodiment is able to perform the change operation in accordance with the operation speed of the user operation. Therefore, it is possible to improve usability.

Furthermore, when it is determined that operation of tracing the display screen is performed as the predetermined operation in a state, in which the display screen is touched as a result of performing touch operation of pressing the display screen, and thereafter maintaining operation of maintaining a state, in which the display screen is touched as a result of performing the predetermined operation, is being performed, the terminal device 10 according to the embodiment performs the second change operation at a speed corresponding to an operation speed of the tracing operation. With this configuration, the terminal device 10 according to the embodiment is able to perform the change operation in accordance with the operation speed of the user operation. Therefore, it is possible to improve usability.

Moreover, the terminal device 10 according to the embodiment performs the second change operation at a speed corresponding to strength with which the display screen is touched due to the maintaining operation. With this configuration, the terminal device 10 according to the embodiment is able to perform the change operation at a speed corresponding to the strength of the maintaining operation performed by the user. Therefore, it is possible to improve usability related to content display.

Furthermore, the terminal device 10 according to the embodiment continues, as the second change operation, at least one of zoom-in operation on a content, zoom-out operation on a content, scroll operation on the content, rotational operation on a content, change operation of changing brightness for displaying a content, change operation of changing contrast for displaying a content, change operation of changing a display mode of a content from two-dimensional display to three-dimensional display, and change operation of changing the display mode of a content from three-dimensional display to two-dimensional display. With this configuration, the terminal device 10 according to the embodiment is able to cope with various kinds of change operation on the content. Therefore, it is possible to improve usability related to content display.

Moreover, when it is determined that the maintaining operation is being performed, the terminal device 10 according to the embodiment starts the second change operation in conjunction with the first change operation that is started in accordance with the predetermined operation and that is performed while focusing on a position at which the maintaining operation included in the predetermined operation is performed, and continues the started second change operation while the maintaining operation is being performed. With this configuration, the terminal device 10 according to the embodiment is able to provide an enlarged view, in which a position that the user wants to enlarge is enlarged. Therefore, it is possible to improve usability related to content display.

Furthermore, the terminal device 10 according to the embodiment starts zoom-in operation or zoom-out operation in conjunction with zoom-in operation or zoom-out operation that is performed with a focus on a position at which maintaining operation included in the predetermined operation is performed, and continues the started zoom-in operation or zoom-out operation while the maintaining operation is being performed. With this configuration, the terminal device 10 according to the embodiment is able to provide an enlarged view, in which a position that the user wants to enlarge is enlarged. Therefore, it is possible to improve usability related to content display.

Moreover, when the maintaining operation is changed to predetermined operation while the second change operation is continued, the terminal device 10 according to the embodiment changes the second change operation to different change operation that is based on the second change operation. With this configuration, the terminal device 10 according to the embodiment is able to improve usability related to content display.

While the embodiments of the present application have been explained in detail above based on the drawings, the embodiments are described by way of example, and the present invention may be embodied in various other forms with various changes or modifications based on knowledge of person skilled in the art, in addition to the embodiments described in this specification.

Furthermore, “a unit” recited in this document may be replaced with “a section, a module, or a means” or “a circuit”. For example, the determining unit may be replaced with a determining means or a determination circuit.

According one aspect of the embodiment, it is possible to improve usability related to content display.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A non-transitory computer-readable recording medium having stored therein an information control program that causes a computer to execute:
determining whether predetermined operation of touching a display screen of a terminal device is performed and thereafter maintaining operation of maintaining a state, in which the display screen is touched as a result of performing the predetermined operation, is being performed; and
controlling including continuing second change operation that is based on first change operation when it is determined, at the determining, that the maintaining operation is being performed, the first change operation being operation started in accordance with the predetermined operation and performed for changing predetermined information related to a content displayed on the display screen.

2. The computer-readable recording medium according to claim 1, wherein the determining includes determining whether the predetermined operation including touch operation of pressing the display screen is performed and thereafter maintaining operation of maintaining a state, in which the display screen is touched as a result of performing the predetermined operation, is being performed.

3. The computer-readable recording medium according to claim 2, wherein the determining includes determining whether the predetermined operation including, as the touch operation, touch operation of successively pressing the display screen a predetermined number of times is performed and thereafter maintaining operation of maintaining a state, in which the display screen is touched as a result of performing the predetermined operation, is being performed.

4. The computer-readable recording medium according to claim 1, wherein the determining includes determining whether the predetermined operation including operation of tracing the display screen is performed and thereafter maintaining operation of maintaining a state, in which the display screen is touched as a result of performing the predetermined operation, is being performed.

5. The computer-readable recording medium according to claim 1, wherein the determining includes determining whether operation of tracing the display screen is performed as the predetermined operation in a state, in which the display screen is touched in a standstill manner as a result of performing touch operation of pressing the display screen, and thereafter maintaining operation of maintaining a state, in which the display screen is performed as a result of performing the predetermined operation, is being performed.

6. The computer-readable recording medium according to claim 1, wherein the determining includes determining whether maintaining operation of maintaining a state, in which the display screen is touched in a standstill manner at a position at which the display screen is touched as a result of performing the predetermined operation, is being performed as the maintaining operation.

7. The computer-readable recording medium according to claim 1, wherein when it is determined, at the determining, that the maintaining operation is being performed, the controlling includes continuing, as the second change operation, change operation that is similar to the first change operation that is started in accordance with the predetermined operation.

8. The computer-readable recording medium according to claim 1, wherein when it is determined, at the determining, that the maintaining operation is being performed, the controlling includes starting the second change operation in conjunction with the first change operation, and continuing the started second change operation while the maintaining operation is being performed.

9. The computer-readable recording medium according to claim 8, wherein the controlling includes starting the second change operation on the basis of a mode in which the display screen is touched due to the maintaining operation.

10. The computer-readable recording medium according to claim 1, wherein the controlling includes terminating the second change operation when it is determined, at the determining, that the maintaining operation is terminated.

11. The computer-readable recording medium according to claim 1, wherein the controlling includes performing the second change operation at a speed corresponding to an operation speed at which the predetermined operation has been performed.

12. The computer-readable recording medium according to claim 1, when it is determined that operation of tracing the display screen is performed as the predetermined operation in a state, in which the display screen is touched as a result of performing touch operation of pressing the display screen, and thereafter maintaining operation of maintaining a state, in which the display screen is touched as a result of performing the predetermined operation, is being performed, the controlling includes performing the second change operation at a speed corresponding to an operation speed of the tracing operation.

13. The computer-readable recording medium according to claim 1, wherein the controlling includes performing the second change operation at a speed corresponding to strength with which the display screen is touched due to the maintaining operation.

14. The computer-readable recording medium according to claim 1, wherein the controlling includes continuing, as the second change operation, at least one of zoom-in operation on the content, zoom-out operation on the content, rotational operation on the content, change operation of changing brightness for displaying the content, change operation of changing a contrast for displaying the content, change operation of changing a display mode of the content from two-dimensional display to three-dimensional display, and change operation of changing the display mode of the content from three-dimensional display to two-dimensional display.

15. The computer-readable recording medium according to claim 1, wherein when it is determined, at the determining, the maintaining operation is being performed, the controlling includes starting the second change operation in conjunction with a first change operation, the first change operation being started in accordance with the predetermined operation and performed while focusing on a position at which maintaining operation included in the predetermined operation is performed, and continuing the started second change operation while the maintaining operation is being performed.

16. The computer-readable recording medium according to claim 15, wherein the controlling includes starting one of zoom-in operation and zoom-out operation in conjunction with zoom-in operation or zoom-out operation that is performed with a focus on a position at which maintaining operation included in the predetermined operation is performed, and continuing the started zoom-in operation or the started zoom-out operation while the maintaining operation is being performed.

17. The computer-readable recording medium according to claim 1, wherein when the maintaining operation is changed to predetermined operation while the second change operation is continued, the controlling includes changing the second change operation to different change operation that is based on the second change operation.

18. An information control method implemented by a terminal device, the information control method comprising:
determining whether predetermined operation of touching a display screen of the terminal device is performed and thereafter maintaining operation of maintaining a state, in which the display screen is touched as a result of performing the predetermined operation, is being performed; and
controlling including continuing second change operation that is based on first change operation when it is determined, at the determining, that the maintaining operation is being performed, the first change operation being operation started in accordance with the predetermined operation and performed for changing predetermined information related to a content displayed on the display screen.

19. A terminal device comprising:
a determining unit configured to determine whether predetermined operation of touching a display screen of a terminal device is performed and thereafter maintaining operation of maintaining a state, in which the display screen is touched as a result of performing the predetermined operation, is being performed; and
an information control unit that, when the determining unit determines that the maintaining operation is being performed, continues second change operation that is based on first change operation, the first change operation being operation started in accordance with the predetermined operation and performed for changing predetermined information related to a content displayed on the display screen.
